(19) United States
(12) Patent Application Publication
(10) Pub. No.: US 2016/0207823 A1
(43) Pub. Date: Jul. 21, 2016

(54) Glass Composition for Chemically Strengthened Alkali-Aluminosilicate Glass and Method for the Manufacture Thereof

(71) Applicant: KORNERSTONE MATERIALS TECHNOLOGY COMPANY, LTD., Fuzhou (CN)

(72) Inventors: DING Jack Y., Fuzhou City (CN); CHEN Cherry, Fuzhou City (CN); LIANG Peter, Fuzhou City (CN); CAI Danny, Fuzhou City (CN)

(21) Appl. No.: 14/913,619

(22) PCT Filed: Aug. 26, 2014
(86) PCT No.: PCT/CN2014/085178

§ 371 Date: Feb. 22, 2016

(30) Foreign Application Priority Data
Aug. 27, 2013 (CN) 201310384108.0

(51) Int. Cl. C03C 3/091; C03C 21/00; C03C 3/085

(52) U.S. Cl. CPC C03C 3/091; C03C 3/085; C03C 21/002

(57) ABSTRACT

A glass composition for producing chemically strengthened alkali-aluminosilicate glass and a method for manufacturing the chemically strengthened alkali-aluminosilicate glass. The chemically strengthened alkali-aluminosilicate glass is suitable for use as high-strength cover glass for touch displays, solar cell cover glass and laminated safety glass.

### FIELD OF THE INVENTION

The present invention relates to a glass composition for chemically strengthened alkali-aluminosilicate glass, a method for manufacturing the chemically strengthened alkali-aluminosilicate glass and applications and uses for the chemically strengthened alkali-aluminosilicate glass.

### BACKGROUND

Chemically strengthened glass is typically significantly stronger than annealed glass due to the glass composition and the chemical strengthening process used to manufacture the glass. Such chemical strengthening processes can be used to strengthen glass of all sizes and shapes without creating optical distortion which enables the production of thin, small, and complex-shaped glass samples that are not capable of being tempered thermally. These properties have made chemically strengthened glass, and more specifically, chemically strengthened alkali-aluminosilicate glass, a popular and widely used choice for consumer mobile electronic devices such as smart phones, tablets and notepads.

The chemical strengthening processes typically include an ion exchange process. In such ion exchange processes, the glass is placed in a heated solution containing ions having a larger ionic radius than the ions present in the glass, such that the smaller ions present in the glass are replaced by larger ions from the heated solution. Typically, potassium ions in the heated solution replace smaller sodium ions present in the glass. After the ion exchange process, a surface compressive stress (“CS”) layer is formed on the glass surface. The compressive stress of the surface compressive stress layer is caused by the substitution during chemical strengthening of an alkali metal ion having a larger ionic radius. The depth of the surface compressive stress layer is generally referred to as the CS depth of layer (“DOL”). A central tension zone (“CT”) is also formed at the same time between the CS layers on both sides of the glass. The ratio of the compressive stress to the depth of layer, expressed as CS/DOL, is directly correlated to the strength and thinness of such chemically strengthened alkali-aluminosilicate glass.

Chemically strengthened alkali-aluminosilicate glass is typically made by either the floating method or the overflow fusion down-draw process. The CS/DOL ratio of conventional products, such as Gorilla® Glass 2 and Gorilla® Glass 3 which are commercially available from Corning Inc., Dragontrail® which is commercially available from Asahi Glass Co, Ltd. and Xensation® which is commercially available from Schott Corporation generally have a CS/DOL ratio of less than 30. This implies that in order to obtain a higher surface compressive stress for such conventional products, the depth of the surface compressive stress layer must be increased. Increasing the depth of the surface compressive stress layer, however, is not a practical solution since it results in an increase in the thickness of the glass.

In addition, a longer ion exchange process is generally required to increase the depth of the surface compressive stress layer. Moreover, the larger the depth of the surface compressive stress layer, the more difficult it is to process the glass. Specifically, in order to cut the glass with a smooth edge and without chips, the scribing wheel of the glass cutting machine must penetrate into the glass to a depth that is greater than the depth of the surface compressive stress layer. Obviously, as the depth of the surface compressive stress layer increases the more difficult it is to cut the glass.

As the electronic mobile device market continues to demand thinner and thinner cover glass, the depth of the surface compressive stress layer must concomitantly decrease. In order to produce a viable cover glass with suitable properties, a chemically strengthened glass with an increased CS/DOL ratio but without an increase in the DOL is needed.

### DETAILED DESCRIPTION

In several exemplary embodiments, the present invention provides an ion-exchangeable glass composition for producing chemically strengthened alkali-aluminosilicate glass having a surface compressive stress layer with high compressive stress (CS) and a low depth of layer (DOL) which thus has an enhanced CS/DOL ratio. The high compressive stress (CS) together with the low depth of layer (DOL) is obtained through a chemical strengthening process in which sodium ions on the glass surface are replaced by larger potassium ions. A low DOL is beneficial for glass finishing since the yield of the scribing process is increased. Also, a glass surface with high compressive stress yields a stronger glass that can withstand increased external impaction forces.

In several exemplary embodiments, the ion-exchangeable glass composition for producing chemically strengthened alkali-aluminosilicate glass includes:
from about 60.0 to about 70.0 mole percent (mol %) of silicon dioxide (SiO₂),
from about 6.0 to about 12.0 mol % of aluminum oxide (Al₂O₃),
at least about 10.5 mol % of sodium oxide (Na₂O),
from about 0 to about 5.0 mol % of boron trioxide (B₂O₃),
from about 0 to about 0.4 mol % of potassium oxide (K₂O),
at least about 8.0 mol % of magnesium oxide (MgO),
from about 0 to about 6.0 mol % of zinc oxide (ZnO) and
from about 0 to about 2.0 mol % of Li₂O,
wherein 13.0 mol % is <Li₂O+Na₂O+K₂O.

According to several exemplary embodiments, the ion-exchangeable glass composition for producing chemically strengthened alkali-aluminosilicate glass includes from about 60.0 to about 70.0 mol % of silicon dioxide (SiO₂). Silicon dioxide is the largest single component of the alkali-aluminosilicate glass composition and forms the matrix of the glass. Silicon dioxide also serves as a structural coordinator of the glass and contributes formability, rigidity and chemical durability to the glass. At concentrations above 70.0 mol %, silicon dioxide raises the melting temperature of the glass composition such that the molten glass becomes very difficult to handle which may result in difficult forming. At concentrations below 60.0 mol %, silicon dioxide detrimentally tends to cause the liquidus temperature of the glass to substantially increase, especially in glass compositions having a high concentration of sodium oxide or magnesium oxide, and also tends to cause devitrification of the glass.

According to several exemplary embodiments, the ion-exchangeable glass composition for producing chemically strengthened alkali-aluminosilicate glass includes from about 6.0 to about 12.0 mol % of aluminum oxide (Al₂O₃). At concentrations of about 6.0 to about 12.0 mol %, the aluminum oxide enhances the strength of the chemically strengthened alkali-aluminosilicate glass and facilitates the ion-exchange between sodium ions in the surface of the glass and potassium ions in the ion exchange solution. At concentrations of aluminum oxide above 15.0 mol %, the viscosity of the glass becomes prohibitively high and tends to devitrify the glass and the liquidus temperature becomes too high to perform a continuous sheet forming process.

According to several exemplary embodiments, the ion-exchangeable glass composition for producing chemically strengthened alkali-aluminosilicate glass includes at least about 10.5 mol % of sodium oxide (Na₂O). In several exemplary embodiments, the ion-exchangeable glass composition for producing chemically strengthened alkali-aluminosilicate glass includes from about 10.5 to about 20.0 mol % of sodium oxide. In several exemplary embodiments, the ion-exchangeable glass composition for producing chemically strengthened alkali-aluminosilicate glass includes from about 14.0 to about 20.0 mol % of sodium oxide. Alkali metal oxides serve as aids in achieving low liquidus temperatures and low melting temperatures. In the case of sodium, Na₂O is used to enable successful ion exchange. In order to permit sufficient ion exchange to produce substantially enhanced glass strength, sodium oxide is included in the composition in the concentrations set forth above. Also, to increase the possibility of ion exchange between sodium ions and potassium ions, according to several exemplary embodiments, the ion-exchangeable glass composition for producing chemically strengthened alkali-aluminosilicate glass includes from about 0 to about 0.4 mol % of potassium oxide (K₂O).

According to several exemplary embodiments, the ion-exchangeable glass composition for producing chemically strengthened alkali-aluminosilicate glass includes from about 0 to about 2.0 mol % of lithium oxide (Li₂O). According to several exemplary embodiments, the ion-exchangeable glass composition for producing chemically strengthened alkali-aluminosilicate glass includes a combined total of more than 13.0 mol % of lithium oxide (Li₂O), sodium oxide (Na₂O) and potassium oxide (K₂O).

According to several exemplary embodiments, the ion-exchangeable glass composition for producing chemically strengthened alkali-aluminosilicate glass includes from about 0 to about 5.0 mol % of boron trioxide (B₂O₃). Boron trioxide serves as a flux as well as a glass coordinator. Also, the glass melting temperature tends to decrease with an increasing concentration of boron trioxide, however, the direction of ion-exchange between sodium and potassium ions is negatively affected by an increasing concentration of boron trioxide. Thus, there is a trade-off between the meltability of the glass and the ion-exchangeability of the glass with an increasing concentration of boron trioxide.

According to several exemplary embodiments, the ion-exchangeable glass composition for producing chemically strengthened alkali-aluminosilicate glass includes at least 8.0 mol % of magnesium oxide (MgO). In several exemplary embodiments, the ion-exchangeable glass composition for producing chemically strengthened alkali-aluminosilicate glass includes from about 8.0 to about 12.0 mol % of magnesium oxide. At concentrations of at least 8.0 mol % of magnesium oxide (MgO), the ratio of compressive stress to the depth of the compressive stress layer increases dramatically. Magnesium oxide is also believed to increase the strength of the glass and to decrease the specific weight of the glass as compared to other alkaline oxides such as calcium oxide (CaO), strontium oxide (SrO) and barium oxide (BaO).

According to several exemplary embodiments, the ion-exchangeable glass composition for producing chemically strengthened alkali-aluminosilicate glass includes a combined total content of sodium oxide (Na₂O) and magnesium oxide (MgO) of from about 22.4 to about 24.3 mol %.

According to several exemplary embodiments, the ion-exchangeable glass composition for producing chemically strengthened alkali-aluminosilicate glass includes a ratio of the combined total content of sodium oxide (Na₂O) and magnesium oxide (MgO) to the combined total content of silicon dioxide (SiO₂) and aluminum oxide (Al₂O₃) of from about 0.29 to about 0.33.

According to several exemplary embodiments, the ion-exchangeable glass composition for producing chemically strengthened alkali-aluminosilicate glass includes from about 0 to about 6.0 mol % of zinc oxide (ZnO). According to several exemplary embodiments, the ion-exchangeable glass composition for producing chemically strengthened alkali-aluminosilicate glass includes from about 1.0 to about 2.5 mol % of zinc oxide. Zinc oxide as well as magnesium oxide (MgO) enhances the ion exchange rate especially compared to other divalent ion oxides such as calcium oxide (CaO), strontium oxide (SrO) and barium oxide (BaO).

According to several exemplary embodiments of the ion-exchangeable glass composition for producing chemically strengthened alkali-aluminosilicate glass described above, the glass has a liquidus temperature (the temperature at which a crystal is first observed) of at least about 900° C. According to several exemplary embodiments of the ion-exchangeable glass composition for producing chemically strengthened alkali-aluminosilicate glass described above, the glass has a liquidus temperature of at least about 950° C. According to several exemplary embodiments of the ion-exchangeable glass composition for producing chemically strengthened alkali-aluminosilicate glass described above, the glass has a liquidus temperature of at least about 1000° C. According to several exemplary embodiments of the ion-exchangeable glass composition for producing chemically strengthened alkali-aluminosilicate glass described above, the glass has a liquidus temperature of up to about 1100° C. According to several exemplary embodiments of the ion-exchangeable glass composition for producing chemically strengthened alkali-aluminosilicate glass described above, the glass has a liquidus temperature of from about 900° C. to about 1100° C.

According to several exemplary embodiments, the present invention provides a method for manufacturing a chemically strengthened alkali-aluminosilicate glass. According to several exemplary embodiments, the method includes:
mixing and melting the components to form a homogenous glass melt;
shaping the glass using the down-draw method, the floating method and combinations thereof;
annealing the glass; and
chemically strengthening the glass by ion exchange.

According to several exemplary embodiments, the manufacture of the chemically strengthened alkali-aluminosilicate glass may be carried out using conventional down-draw methods which are well known to those of ordinary skill in the art and which customarily include a directly or indirectly heated precious metal system consisting of a homogenization device, a device to lower the bubble content by means of fining (refiner), a device for cooling and thermal homogenization, a distribution device and other devices. The floating method includes floating molten glass on a bed of molten metal, typically tin, resulting in glass that is very flat and has a uniform thickness.

According to several exemplary embodiments of the method for manufacturing a chemically strengthened alkali-aluminosilicate glass described above, the ion-exchangeable glass composition is melted for up to about 12 hours at about 1650° C. According to several exemplary embodiments of the method for manufacturing a chemically strengthened alkali-aluminosilicate glass described above, the ion-exchangeable glass composition is melted for up to about 6 hours at about 1650° C. According to several exemplary embodiments of the method for manufacturing a chemically strengthened alkali-aluminosilicate glass described above, the ion-exchangeable glass composition is melted for up to about 4 hours at about 1650° C. According to several exemplary embodiments of the method for manufacturing a chemically strengthened alkali-aluminosilicate glass described above, the ion-exchangeable glass composition is melted for up to about 2 hours at about 1650° C.

According to several exemplary embodiments of the method for manufacturing a chemically strengthened alkali-aluminosilicate glass described above, the ion-exchangeable glass composition is annealed at a rate of about 0.5° C./hour until the glass reaches room temperature (or about 21° C.).

According to several exemplary embodiments, the ion-exchangeable glass composition for producing chemically strengthened alkali-aluminosilicate glass described above is chemically strengthened according to conventional ion exchange conditions. According to several exemplary embodiments of the method for manufacturing a chemically strengthened alkali-aluminosilicate glass described above, the ion exchange process occurs in a molten salt bath. In several exemplary embodiments, the molten salt is potassium nitrate (KNO₃).

According to several exemplary embodiments of the method for manufacturing a chemically strengthened alkali-aluminosilicate glass described above, the ion exchange treatment takes place at a temperature range of from about 390° C. to about 450° C.

According to several exemplary embodiments of the method for manufacturing a chemically strengthened alkali-aluminosilicate glass described above, the ion exchange treatment is conducted for up to about 8 hours. According to several exemplary embodiments of the method for manufacturing a chemically strengthened alkali-aluminosilicate glass described above, the ion exchange treatment is conducted for up to about 4 hours. According to several exemplary embodiments of the method for manufacturing a chemically strengthened alkali-aluminosilicate glass described above, the ion exchange treatment is conducted for up to about 2 hours. According to several exemplary embodiments of the method for manufacturing a chemically strengthened alkali-aluminosilicate glass described above, the ion exchange treatment is conducted for about 2 hours to about 8 hours.

According to several exemplary embodiments of the chemically strengthened alkali-aluminosilicate glass described above, the glass has a surface compressive stress layer having a compressive stress of at least about 500 MPa. According to several exemplary embodiments of the chemically strengthened alkali-aluminosilicate glass described above, the glass has a surface compressive stress layer having a compressive stress of at least about 800 MPa. According to several exemplary embodiments of the chemically strengthened alkali-aluminosilicate glass described above, the glass has a surface compressive stress layer having a compressive stress of at least about 1100 MPa. According to several exemplary embodiments of the chemically strengthened alkali-aluminosilicate glass described above, the glass has a surface compressive stress layer having a compressive stress of up to about 1350 MPa. According to several exemplary embodiments of the chemically strengthened alkali-aluminosilicate glass described above, the glass has a surface compressive stress layer having a compressive stress of from about 500 MPa to about 1350 MPa.

According to several exemplary embodiments of the chemically strengthened alkali-aluminosilicate glass described above, the glass has a compressive stress layer having a depth of at least about 18.5 μM. According to several exemplary embodiments of the chemically strengthened alkali-aluminosilicate glass described above, the glass has a compressive stress layer having a depth of at least about 22.0 μm. According to several exemplary embodiments of the chemically strengthened alkali-aluminosilicate glass described above, the glass has a compressive stress layer having a depth of up to about 35.0 μm. According to several exemplary embodiments of the chemically strengthened alkali-aluminosilicate glass described above, the glass has a compressive stress layer having a depth of from about 18.5 μm to about 35.0 μm.

According to several exemplary embodiments of the chemically strengthened alkali-aluminosilicate glass described above, the glass has a ratio of compressive stress to depth of the compressive stress layer of at least about 26. According to several exemplary embodiments of the chemically strengthened alkali-aluminosilicate glass described above, the glass has a ratio of compressive stress to depth of the compressive stress layer of at least about 30. According to several exemplary embodiments of the chemically strengthened alkali-aluminosilicate glass described above, the glass has a ratio of compressive stress to depth of the compressive stress layer of up to about 70. According to several exemplary embodiments of the chemically strengthened alkali-aluminosilicate glass described above, the glass has a ratio of compressive stress to depth of the compressive stress layer of from about 26 to about 70. According to several exemplary embodiments of the chemically strengthened alkali-aluminosilicate glass described above, the glass has a ratio of compressive stress to depth of the compressive stress layer of from about 30 to about 70. According to several exemplary embodiments of the chemically strengthened alkali-aluminosilicate glass described above, the glass has a ratio of compressive stress to depth of the compressive stress layer of from about 35 to about 70. According to several exemplary embodiments of the chemically strengthened alkali-aluminosilicate glass described above, the glass has a ratio of compressive stress to depth of the compressive stress layer of from about 40 to about 70.

According to several exemplary embodiments of the chemically strengthened alkali-aluminosilicate glass described above, the glass has a thickness of from about 0.3 to about 2.0 mm.

According to several exemplary embodiments of the chemically strengthened alkali-aluminosilicate glass described above, the glass has a density of up to about 2.6 g/cm³ and a linear coefficient of expansion α₂₅₋₃₀₀ 10⁻⁷/° C. in a range of from about 86.0 to about 99.0.

According to several exemplary embodiments of the chemically strengthened alkali-aluminosilicate glass described above, the glass may be used as a protective glass in applications such as solar panels, refrigerator doors, and other household products. According to several exemplary embodiments of the chemically strengthened alkali-aluminosilicate glass described above, the glass may be used as a protective glass for televisions, as safety glass for automated teller machines, and additional electronic products. According to several exemplary embodiments of the chemically strengthened alkali-aluminosilicate glass described above, the glass may be used as cover glass for consumer mobile electronic devices such as smart phones, tablets and note pads. According to several exemplary embodiments of the chemically strengthened alkali-aluminosilicate glass described above, the glass may be used as a touch screen or touch panel due to its high strength.

The following examples are illustrative of the compositions and methods discussed above.

### EXAMPLES

An ion-exchangeable glass composition that included the components shown below in Table 1 was prepared as follows:

TABLE 1

| Oxide | Mol % |
|---|---|
| SiO₂ | 66.0 |
| Al₂O₃ | 9.2 |
| Na₂O | 14.3 |
| B₂O₃ | 0 |
| K₂O | 0 |
| MgO | 8.1 |
| CaO | 0 |
| ZnO | 2.4 |

Batch materials, as shown in Table 2 were weighed and mixed before being added to a 2 liter plastic container. The batch materials used were of chemical reagent grade quality.

TABLE 2

| Batch raw materials | Batch weight (gm) |
|---|---|
| Sand | 352.4 |
| Alumina | 119.1 |
| Soda ash | 138.5 |
| Borax | 0 |
| Potassium carbonate | 0 |
| Magnesia | 28.2 |
| Limestone | 0 |
| Zinc oxide | 17.3 |

The particle size of the sand was between 0.045 and 0.25 mm. A tumbler was used for mixing the raw materials to make a homogenous batch as well as to break up soft agglomerates. The mixed batch was transferred from the plastic container to an 800 ml. platinum-rhodium alloy crucible for glass melting. The platinum-rhodium crucible was placed in an alumina backer and loaded in a high temperature furnace equipped with MoSi heating elements operating at a temperature of 900° C. The temperature of the furnace was gradually increased to 1650° C. and the platinum-rhodium crucible with its backer was held at this temperature for 4 hours. The glass sample was then formed by pouring the molten batch materials from the platinum-rhodium crucible onto a stainless steel plate to form a glass patty. While the glass patty was still hot, it was transferred to an annealer and held at a temperature of 620° C. for 2 hours and was then cooled at a rate of 0.5° C./min to room temperature (21° C.).

The glass sample was then chemically strengthened by placing it in a molten salt bath tank, in which the constituent sodium ions in the glass were exchanged with externally supplied potassium ions at a temperature of 420° C. which was less than the strain point of the glass for 4 hours. By this method, the glass sample was strengthened by ion exchange to produce a compressive stress layer at the treated surface.

The measurement of the compressive stress at the surface of the glass and the depth of the compressive stress layer (based on double refraction) were determined by using a polarization microscope (Berek compensator) on sections of the glass. The compressive stress of the surface of the glass was calculated from the measured dual refraction assuming a stress-optical constant of 0.26 (nm*cm/N) (Scholze, H., Nature, Structure and Properties, Springer-Verlag, 1988, p. 260).

The results for the composition shown in Table 1 above are shown below in Table 3 in the column designated as “Ex. 1”. Additional compositions shown in Table 3 and designated as “Ex. 2” to “Ex. 12” were prepared in a similar manner as described above for the composition designated as Ex. 1.

TABLE 3

| Oxide (mol %) | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|---|
| SiO₂ | 66 | 66.2 | 66.2 | 67.8 | 63.8 | 66 | 65.6 | 65.5 | 68.5 | 70.5 | 67.8 | 66 |
| Al₂O₃ | 9.2 | 9.2 | 10.8 | 9.2 | 10.8 | 9.2 | 9.2 | 9.2 | 7.2 | 5.2 | 7.2 | 7.2 |
| Na₂O | 14.3 | 14.3 | 14.3 | 14.3 | 14.3 | 14.3 | 14.1 | 14.1 | 14.1 | 14.1 | 14.3 | 14.3 |
| B₂O₃ | 0 | 0 | 0 | 0 | 0 | 1.8 | 0 | 1 | 0 | 0 | 0 | 0 |
| K₂O | 0 | 0.4 | 0.4 | 0.4 | 0.4 | 0.4 | 0 | 0 | 0 | 0 | 0 | 0 |
| MgO | 8.1 | 9.9 | 8.3 | 8.3 | 8.3 | 8.3 | 10.1 | 10.2 | 10.2 | 10.2 | 8.3 | 8.3 |
| CaO | 0 | 0 | 0 | 0 | 0 | 0 | 0 | 0 | 0 | 0 | 0 | 0 |
| Li₂O | 0 | 0 | 0 | 0 | 0 | 0 | 0 | 0 | 0 | 0 | 0 | 0 |
| ZnO | 2.4 | 0 | 0 | 0 | 2.4 | 0 | 1 | 0 | 0 | 0 | 2.4 | 4.2 |
| d (g/cm³) | 2.477 | 2.456 | 2.468 | 2.438 | 2.484 | 2.461 | 2.473 | 2.452 | 2.448 | 2.435 | 2.511 | 2.532 |
| Oxygen atom | 7.24 | 7.27 | 7.31 | 7.24 | 7.21 | 7.36 | 7.29 | 7.32 | 7.30 | 7.28 | 7.35 | 7.29 |
| density | | | | | | | | | | | | |
| (mol/cm³) × 10⁻² | | | | | | | | | | | | |
| n_{D} (20° C.) | 1.513 | 1.504 | 1.501 | 1.497 | 1.507 | 1.504 | 1.503 | 1.506 | 1.487 | 1.504 | 1.503 | 1.509 |
| α (×10⁻⁷/° C.) | 87 | 90.8 | 87.6 | 86.3 | 89.5 | 90.9 | 97.3 | 95.8 | 88.1 | 87.2 | 91.78 | 98.7 |
| T_{10e2.5} | 1539 | 1528 | 1604 | 1592 | 1558 | 1526 | 1468 | 1481 | 1533 | 1532 | 1522 | 1464 |
| T_{w} | 1217 | 1205 | 1264 | 1257 | 1215 | 1221 | 1188 | 1176 | 1204 | 1185 | 1197 | 1155 |
| T_{liq} | 1040 | 1050 | 980 | 1015 | 1050 | 960 | 1071 | 1086 | 1035 | 1050 | 1032 | 1026 |
| T_{soft} | 853 | 849 | 870 | 886 | 847 | 830 | 815 | 842 | 868 | 849 | 866 | 792 |
| Tₐ | 641 | 636 | 642 | 638 | 629 | 600 | 580 | 627 | 622 | 609 | 625 | 566 |
| Tₛ | 596 | 593 | 599 | 590 | 586 | 560 | 543 | 584 | 575 | 563 | 575 | 526 |
| VH | 553 | 598 | 604 | 562 | 579 | 581 | 588 | 599 | 578 | 553 | 568 | 566 |
| (kgf/mm²) | | | | | | | | | | | | |
| VHCS | 667 | 683 | 660 | 661 | 690 | 658 | 668 | 669 | 661 | 624 | 666 | 607 |
| (kgf/mm²) | | | | | | | | | | | | |
| CS (MPa) | 944 | 968 | 947 | 1148 | 1064 | 1164 | 1304 | 958 | 842 | 721 | 1001 | 596 |
| DOL (μm) | 21.8 | 22.6 | 26.6 | 34.0 | 24.6 | 29.0 | 19.0 | 19.5 | 24.2 | 26.0 | 19.4 | 22.6 |
| CS | 43 | 43 | 36 | 34 | 43 | 40 | 69 | 49 | 35 | 28 | 52 | 26 |
| (MPa)/DOL(μm) | | | | | | | | | | | | |

The definitions of the symbols set forth in Table 3 are as follows:
d: density (g/ml), which is measured with the Archimedes method (ASTM C693);
n_{D}: refractive index, which is measured by refractometry;
α: coefficient of thermal expansion (CTE) which is the amount of linear dimensional change from 25 to 300° C., as measured by dilatometry;
T_{10e2.5}: the temperature at the viscosity of 10^{2.5} poise, as measured by high temperature cylindrical viscometry;
T_{w}: glass working temperature at the viscosity of 10⁴ poise;
T_{liq}: liquidus temperature where the first crystal is observed in a boat within a gradient temperature furnace (ASTM C829-81), generally test is 72 hours for crystallization;
T_{soft}: glass softening temperature at the viscosity of 10^{7.6} poise as measured by the fiber elongation method;
Ta: glass annealing temperature at the viscosity of 10¹³ poise as measured by the fiber elongation method;
Ts: glass strain temperature at the viscosity of 10^{14.5} poise and measured by the fiber elongation method;
VH: Vicker's Hardness;
VH_{cs}: Vicker's Hardness after chemical strengthening;
CS: compressive stress (in-plane stress which tends to compact the atoms in the surface);
DOL: depth of layer which represents the depth of the compressive stress layer below the surface to the nearest zero stress plane;
CS/DOL: ratio of compressive stress to depth of layer

While the present invention has been described in terms of certain embodiments, those of ordinary skill in the art will recognize that the invention can be practiced with modification within the spirit and scope of the appended claims.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The present disclosure has been described relative to certain embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. An ion-exchangeable glass composition for producing chemically strengthened alkali-aluminosilicate glass, comprising:
from about 60.0 to about 70.0 mol % of SiO₂,
from about 6.0 to about 12.0 mol % of Al₂O₃,
at least about 10.5 mol % of Na₂O,
from about 0 to about 5.0 mol % of B₂O₃,
from about 0 to about 0.4 mol % of K₂O,
at least about 8.0 mol % of MgO,
from about 0 to about 6.0 mol % of ZnO, and
from about 0 to about 2.0 mol % of Li₂O,
wherein 13.0 mol % is <Li₂O+Na₂O+K₂O.

2. The ion-exchangeable glass composition according to claim 1, wherein the glass composition comprises from about 10.5 to about 20.0 mol % of Na₂O.

3. The ion-exchangeable glass composition according to claim 2, wherein the glass composition comprises from about 14.0 to about 20.0 mol % of Na₂O.

4. The ion-exchangeable glass composition according to claim 1, wherein the glass composition comprises from about 8.0 to about 12.0 mol % of MgO.

5. The ion-exchangeable glass composition according to claim 1, wherein 22.4 mol %<Na₂O+MgO<24.3 mol %.

6. The ion-exchangeable glass composition according to claim 1, wherein 0.29<(Na₂O+MgO)/(SiO₂+Al₂O₃)<0.33.

7. The ion-exchangeable glass composition according to claim 1, wherein the glass composition comprises from about 1.0 to 2.5 mol % of ZnO.

8-11. (canceled)

12. The ion-exchangeable glass composition according to claim 1, wherein the glass composition has a liquidus temperature of from about 900° C. to about 1100° C.

13. A chemically strengthened alkali-alumino-silicate glass made from a glass composition comprising:
from about 60.0 to about 70.0 mol % of SiO₂,
from about 6.0 to about 12.0 mol % of Al₂O₃,
at least about 10.5 mol % of Na₂O,
from about 0 to about 5.0 mol % of B₂O₃,
from about 0 to about 0.4 mol % of K₂O,
at least about 8.0 mol % of MgO, and
from about 0 to about 6.0 mol % of ZnO, and
from about 0 to about 2.0 mol % of Li₂O,
wherein 13.0 mol % is <Li₂O+Na₂O+K₂O;
wherein the glass composition is ion-exchanged and has a surface compressive stress layer;
wherein the surface compressive stress layer has a compressive stress and a depth; and
wherein the ratio of the compressive stress of the surface compressive stress layer to the depth of the surface compressive stress layer is at least about 26.

14. The chemically strengthened alkali-alumino-silicate glass according to claim 13, wherein the glass composition comprises:
from about 14.0 to about 20.0 mol % of Na₂O, and
from about 8.0 to about 12.0 mol % of MgO.

15-18. (canceled)

19. The chemically strengthened alkali-alumino-silicate glass according to claim 13, wherein the surface compressive stress layer has a compressive stress of from about 500 MPa to about 1350 MPa.

20-22. (canceled)

23. The chemically strengthened alkali-aluminosilicate glass according to claim 13, wherein the depth of the surface compressive stress layer is from about 18.5 μm to about 35.0 μm.

24. (canceled)

25. The chemically strengthened alkali-aluminosilicate glass according to claim 13, wherein the ratio of the compressive stress of the surface compressive stress layer to the depth of the surface compressive stress layer is about 26 to about 70.

26-28. (canceled)

29. The chemically strengthened alkali-aluminosilicate glass according to claim 13, wherein the glass has a thickness of from about 0.3 to about 2.0 mm.

30. The chemically strengthened alkali-aluminosilicate glass according to claim 13, wherein the glass has a density of up to about 2.6 g/cm³.

31. The chemically strengthened alkali-aluminosilicate glass according to claim 13, wherein the glass has a linear coefficient of expansion (α₂₅₋₃₀₀ 10⁻⁷/° C.) of from about 86.0 to about 99.0.

32. A method for producing a chemically strengthened alkali-aluminosilicate glass, comprising:
mixing and melting glass raw material components to form a homogenous glass melt comprising:
from about 60.0 to about 70.0 mol % of SiO₂,
from about 6.0 to about 12.0 mol % of Al₂O₃,
at least about 10.5 mol % of Na₂O,
from about 0 to about 5.0 mol % of B₂O₃,
from about 0 to about 0.4 mol % of K₂O,
at least about 8.0 mol % of MgO,
from about 0 to about 6.0 mol % of ZnO, and
from about 0 to about 2.0 mol % of Li₂O,
wherein 13.0 mol % is <Li₂O+Na₂O+K₂O;
shaping the glass using a method selected from a down-draw method, a floating method and combinations thereof;
annealing the glass; and
chemically strengthening the glass by ion exchange.

33. The method of claim 32, wherein the glass raw material components are melted for up to about 12 hours at a temperature of about 1650° C.

34. The method of claim 33, wherein the glass raw material components are melted for up to about 6 hours at a temperature of about 1650° C.

35. The method of claim 34, wherein the glass raw material components are melted for up to about 4 hours at a temperature of about 1650° C.

36. The method of claim 35, wherein the glass raw material components are melted for up to about 2 hours at a temperature of about 1650° C.

37. The method of claim 32, wherein the glass is annealed at a rate of about 0.5° C./hour.

38. The method of claim 32, wherein the glass is chemically strengthened by ion exchange in a molten salt bath.

39. The method of claim 38, wherein the molten salt is KNO₃.

40. The method of claim 32, wherein the glass is chemically strengthened by ion exchange at a temperature of from about 390° C. to about 450° C.

41-43. (canceled)

44. The method of claim 32, wherein the glass is chemically strengthened by ion exchange for about 2 hours to about 8 hours.
